(19) United States
(12) Patent Application Publication
(10) Pub. No.: US 2010/0009582 A1
(43) Pub. Date: Jan. 14, 2010

(54) POLYURETHANE UREA SOLUTIONS

(75) Inventors: Jüergen Köcher, Langenfeld (DE); Thorsten Rische, Unna (DE); Juergen Urban, Bergisch-Gladbach (DE); Eva Urban, Koln (DE); Anne Urban, Koln (DE); Holger Casselmann, Odenthal (DE); Thomas Feller, Solingen (DE)

Correspondence Address: CONNOLLY BOVE LODGE & HUTZ, LLP, P O BOX 2207, WILMINGTON, DE, 19899, US

(73) Assignee: Bayer MaterialScience AG, Leverkusen (DE)

(21) Appl. No.: 12/500,243

(22) Filed: Jul. 9, 2009

(30) Foreign Application Priority Data
Jul. 11, 2008 (DE) 102008032779.4

(51) Int. Cl. C09D 175/04; B32B 5/02; B32B 27/06

(52) U.S. Cl. 442/59; 524/590; 428/423.4

(57) ABSTRACT

The present invention relates to polyurethane ureas dissolved in organic solvents, which may be used as an adhesive coat for the coating of textiles.

### RELATED APPLICATIONS

This application claims benefit to German Patent Application No. 10 2008 032 779.4, filed Jul. 11, 2008, which is incorporated herein by reference in its entirety for all useful purposes.

### BACKGROUND OF THE INVENTION

The invention relates to novel solutions of polyurethane ureas having improved solubility in toxicologically harmless organic solvents, a process for the coating of substrates using these solutions of polyurethane ureas and the substrates coated in this way.

The substrates coated according to the invention are preferably textile products or leathers, but materials such as wood or concrete can also be coated according to the invention.

The coating of substrates, for example textile fabrics, with polyurethane systems belongs to the state of the art. A distinction is made here between water-based polyurethane dispersions and solvent-based systems. Both coating systems are distinguished by high elasticity together with good resistance.

One-component polyurethane urea coatings based on organic solvents are highly valued by users on account of their hardness, elasticity and resistance, and are used e.g. for the production of adhesive coats on textile substrates. The term adhesive coat is understood as that layer in a multilayer coating which is applied directly to the textile substrate and acts as an adhesion promoter for further coatings. Adhesive coats made of water-based polyurethane dispersions are often insufficiently stable on textile substrates, and so polyurethane ureas in organic solution are preferably used for the production of adhesive coats.

In the case of these one-component polyurethane ureas in organic solution, the film-forming process is a physical operation which, in contrast to the two-component polyurethanes, is not accompanied by a chemical reaction.

Adhesive coat systems with particularly resistant and elastic coatings consist of a mixture of urethane soft segments with a long-chain, linear diol and urethane hard segments with a short-chain diol as well as urea hard segments. Systems of this kind in organic solution are produced by reacting a diisocyanate with a linear macrodiol (polyether, polyester or polycarbonate diol) to form a prepolymer and then adjusted by reaction with a short-chain diol and with an aliphatic diamine as chain extender to give the required molecular weight (DE-A 199 14 879 and EP-A 1 041 097). The diisocyanates used to produce the urethane bond are aromatic diisocyanates such as isomeric diphenylmethane diisocyanates, e.g. diphenylmethane 4,4′-diisocyanate (MDI), or isomer mixtures of toluene 2,4- and 2,6-diisocyanate (TDI). A highly suitable adhesive coat system is found in EP-A 1 041 097 in example 1, which describes an MDI-based polyurethane urea polymer in a DMF-containing solvent mixture.

The hard segments with their marked tendency to form strong hydrogen bridge bonds bring about the high resistance and elasticity of the coating applied to and dried on the textile fabric. At the same time, however, owing to these hydrogen bridge bonds, these coating solutions have a tendency towards associations and crystallisations out of the organic solution. As a result of this association and crystallisation tendency, even the synthesis of these polyurethane ureas is only possible in very highly polar solvents, such as e.g. dimethylformamide (DMF), dimethylacetamide or N-methyl-pyrrolidone (NMP), in proportions of 20-60%, based on total solvent (DE-A 2 252 280, DE-A 2 457 387 and Eur. Polym. J. 28 (6), 1992 (637-642).

If an attempt is made to synthesise the polyurethane urea solution of example 1 of EP-A 1 041 097 without DMF, NMP or dimethylacetamide as an essential component of the solvent mixture used, it is not possible to produce a polymer with a sufficiently high molecular weight and sufficiently high viscosity. The poor solubility of the polymers that form in a solvent mixture with low polarity prevents further reaction to form sufficiently high molecular weight products, since low molecular weight products already precipitate out of the solution. Until the present, therefore, all known one-component polyurethane urea solutions that are used to produce adhesive coats on textile fabrics have contained very large quantities of polar, but toxicologically harmful, solvents, such as e.g. dimethylformamide (DMF). In future, solvents such as DMF are to be avoided as far as possible for the production and use of adhesive coats based on polyurethane ureas.

It is possible to synthesise soluble polyurethane urea polymers in a less polar solvent system if the number of hard segments consisting of short-chain urethanes and urea groups is reduced in comparison to the long-chain soft segments. However, in this case there is a reduction in the elasticity and resistance as well as a lowering of the softening point of the coating made from the one-component system.

In order to be able to continue using one-component polyurethane urea solutions for adhesive coats for textile substrates with the known good property profile, there is therefore a need for the development of novel polyurethane systems which are both capable of being produced, dissolved and also processed even in toxicologically harmless solvent systems and also possess good elasticity, high resistance and a sufficiently high softening point.

On the one hand, it must be possible to produce the novel products in less polar solvent mixtures which are non-hazardous to health. In addition, these formulations or solutions must be stable, which means in particular that the dissolved polymers must not precipitate or crystallise out, so that the solutions exhibit high storage stability. A low and sufficiently stable viscosity is also needed for good processability of the coating solution. The increase in viscosity as far as the formation of gels, as is known for polyurethane ureas of this kind (D. Joel, W. Hettrich and R. Becker, Polymer 1993, 34(12), 2623-2627), should therefore likewise be avoided in the novel products.

### EMBODIMENTS OF THE INVENTION

An embodiment of the present invention is a polyurethane urea solution obtained by reacting
a) a bifunctional polyether diol having a molecular weight in the range of from 500 to 16000 or mixtures of these macrodiols;
b) from 0.6 to 1.6 moles, per mole of a), of a low molecular weight bifunctional alcohol having a molecular weight in the range of from 32 to 500 or mixtures of these bifunctional alcohols;
c) from 0.05 to 0.35 moles, per mole of a), of an aliphatic or cycloaliphatic bifunctional amine having a molecular weight in the range of from 28 to 500 or mixtures of these bifunctional amines;
d) from 1.7 to 3.0 moles, per mole of a), of an aromatic diisocyanate;
   wherein the overall functionality of a) is in the range of from 1.95 to 2.05; to form a polyurethane urea, wherein said polyurethane urea is dissolved in or prepared in
e) from 40 to 85 weight %, based on the total weight of (a) through (e), of a solvent selected from the group consisting of linear and cyclic esters, linear and cyclic ethers, linear and cyclic alcohols, and linear and cyclic ketones.

Yet another embodiment of the present invention is a coating prepared from the above polyurethane urea solution.

Yet another embodiment of the present invention is a substrate coated with the above coating.

Another embodiment of the present invention is the above substrate, wherein said polyurethane urea solution is applied to said substrate by printing, spraying, knife coating, or transfer coating.

Another embodiment of the present invention is the above substrate, wherein said substrate is a textile.

Another embodiment of the present invention is the above substrate, wherein said substrate is leather.

Another embodiment of the present invention is the above coating, wherein said coating is an adhesive coating.

Another embodiment of the present invention is the above polyurethane urea solution, wherein
a) is a mixture of two bifunctional polyether diols each having a molecular weight in the range of from 500 to 5000, wherein the molar mixing ratio of said two bifunctional polyether diols is in the range of from 10:90 to 90:10;
b) is from 0.7 to 1.5 motes, per mole of a), of a mixture of two low molecular weight bifunctional alcohols each having a molecular weight in the range of from 32 to 500, wherein the molar mixing ratio of said two low molecular weight bifunctional alcohols is in the range of from 10:90 to 90:10;
c) is from 0.08 to 0.33 moles, per mole of a), of an aliphatic or cycloaliphatic bifunctional amine having a molecular weight in the range of from 28 to 500;
d) is from 1.8 to 2.9 moles, per mole of a), of an aromatic diisocyanate; and
e) is from 40 to 85 weight % of a solvent selected from the group consisting of linear and cyclic esters and linear and cyclic ketones.

Yet another embodiment of the present invention is a coating prepared from the above polyurethane urea solution.

Yet another embodiment of the present invention is a substrate coated with the above coating.

Another embodiment of the present invention is the above substrate, wherein said polyurethane urea solution is applied to said substrate by printing, spraying, knife coating, or transfer coating.

Another embodiment of the present invention is the above substrate, wherein said substrate is a textile.

Another embodiment of the present invention is the above substrate, wherein said substrate is leather.

Another embodiment of the present invention is the above coating, wherein said coating is an adhesive coating.

Another embodiment of the present invention is the above polyurethane urea solution, wherein
a) is a mixture of two bifunctional polyether diols each having a molecular weight in the range of from 500 to 5000, wherein the molar mixing ratio of said two bifunctional polyether diols is in the range of from 30:70 to 170:30;
b) is from 0.8 to 1.4 moles, per mole of a), of a mixture of two low molecular weight bifunctional alcohols each having a molecular weight in the range of from 32 to 500, wherein the molar mixing ratio of said two low molecular weight bifunctional alcohols is in the range of from 30:70 to 70:30;
c) is from 0.10 to 0.30 moles, per mole of a), of an aliphatic or cycloaliphatic bifunctional amine having a molecular weight of from 28 to 500;
d) is from 1.9 to 2.8 moles, per mole of a), of diphenylmethane 4,4′-diisocyanate; and
e) is from 50 to 75 weight % of a solvent mixture consisting of γ-butyrolactone together with esters and ketones.

Yet another embodiment of the present invention is a coating prepared from the above polyurethane urea solution.

Yet another embodiment of the present invention is a substrate coated with the above coating.

Another embodiment of the present invention is the above substrate, wherein said polyurethane urea solution is applied to said substrate by printing, spraying, knife coating, or transfer coating.

Another embodiment of the present invention is the above substrate, wherein said substrate is a textile.

Another embodiment of the present invention is the above substrate, wherein said substrate is leather.

Another embodiment of the present invention is the above coating, wherein said coating is an adhesive coating.

### DESCRIPTION OF THE INVENTION

The present invention provides the preparation of novel stable polyurethane urea coating solutions in toxicologically harmless solvents, which are not only suitable for the production of adhesive coats on textile fabrics but which are also equal to the systems used currently, e.g. those in DMF, in terms of product properties and stability of the polymer solution.

This object was achieved with the aid of polyurethane urea solutions consisting of linear or slightly branched polyurethane ureas, wherein the polyurethane urea solution is made up of
a) a bifunctional polyether diol with a molecular weight of between 500 and 16000 or of mixtures of said macrodiol components,
b) per mole polyether diol or per mole polyether diol mixture, 0.6-1.6 moles of a low molecular weight bifunctional alcohol with a molecular weight of 32 to 500or mixtures of said bifunctional alcohols as a so-called chain-extender,
c) per mole polyether diol or per mole polyether diol mixture, 0.05-0.35 moles of an aliphatic or cycloaliphatic bifunctional amine with a molecular weight of 28 to 500 or mixtures of said bifunctional amines as so-called chain extenders,
d) per mole polyether diol or per mole polyether diol mixture, 1.7-3.0 moles aromatic diisocyanate,
e) 40-85 wt. % solvents or solvent mixtures from the series of the linear or cyclic esters, ethers, alcohols and ketones.

Preferably according to the invention, polyurethane ureas are used which are made up of
a) a mixture of two bifunctional polyether diols each having a molecular weight of between 500 and 5000, wherein the molar mixing ratio of the two components is to be selected between 10:90 and 90:10,
b) per mole polyether diol mixture, 0.7-1.5 moles of a mixture of two low molecular weight bifunctional alcohols with a molecular weight of 32 to 500 as so-called chain extenders, wherein the molar mixing ratio of the two components is to be selected between 10:90 and 90:10,
c) per mole polyether diol mixture, 0.08-0.33 moles of an aliphatic or cycloaliphatic bifunctional amine with a molecular weight of 28 to 500 as a so-called chain extender,
d) per mole polyether diol mixture, 1.8-2.9 moles of an aromatic diisocyanate,
e) 40-85 wt. % of a solvent mixture consisting of linear or cyclic esters and ketones.

Particularly preferably according to the invention, polyurethane ureas are used which are made up of
a) a mixture of two bifunctional polyether diols with molecular weights of between 500 and 5000, wherein the molar mixing ratio of the two components is to be selected between 30:70 and 70:30,
b) per mole polyether diol mixture, 0.8-1.4 moles of a mixture of two bifunctional alcohols with a molecular weight of 32 to 500 as so-called chain extenders, wherein the molar mixing ratio of the two components is to be selected between 30:70 and 70:30,
c) per mole polyether diol mixture, 0.1-0.30 moles of an aliphatic or cycloaliphatic bifunctional amine with a molecular weight of 28 to 500 as a so-called chain extender,
d) per mole polyether diol mixture, 1.9-2.8 moles of diphenylmethane 4,4′-diisocyanate (4,4′-MDI)
e) 50-75 wt. % of a solvent mixture consisting of γ-butyrolactone together with esters and ketones.

The polyurethane ureas contained in the coating compositions according to the invention for textile fabrics are high molecular weight, but practically uncrosslinked, thermoplastic polyurethane ureas, which are produced in solution or in the melt. They are characterised among other things in that they can be produced and used without the incorporation of dimethylformamide, dimethylacetamide, N-methyl-pyrrolidone or other toxicologically harmful, highly polar solvents. In comparison to the product of example 1 from EP-A 1 041 097, the products according to the invention contain more soft than hard segments and are therefore soluble in less polar solvent mixtures but nevertheless possess the high level of resistance and elasticity and the high softening point needed for adhesive coats.

The term “polyurethane urea solution” also includes solutions which contain e.g. trimer, uretdione, allophanate and/or biuret structural units in subordinate quantities in addition to urethane and urea structural units.

As components of the polyurethanes on which the coating compositions according to the invention are based, a large number of polyurethane raw materials, which are known in principle, are suitable.

Suitable in principle are polyether diols (a) without significant proportions of more highly functional diols. The total functionality should be in the range of 1.95-2.05. A higher functionality of the polyether diols should be avoided as the resulting polyurethane solutions obtain a very high viscosity because of the high crosslinking, which is disadvantageous for processing as a coating solution. The high crosslinking also prevents the resulting polyurethane solutions from being stable over several months, as required by the market.

The polyether diols containing hydroxyl groups that are suitable are those produced by polymerisation of cyclic ethers, such as ethylene oxide, propylene oxide, butylene oxide, tetrahydrofuran, styrene oxide or epichlorohydrin, with themselves, e.g. in the presence of BF₃ or basic catalysts, or by addition of these ring compounds, optionally in a mixture or successively, to starting components with reactive hydrogen atoms, such as alcohols, e.g. ethylene glycol, 1,2-propylene glycol or 1,3-propylene glycol, amines or water.

In addition to the polyether diols a), low molecular weight bifunctional alcohols b) are also employed. Both aliphatic and aromatic diols may be used, with the aliphatic diols being preferred. Suitable as these short-chain aliphatic diols are, for example: ethylene glycol, 1,2-propylene glycol, 1,3-propylene glycol, neopentyl glycol, diethylene glycol, triethylene glycol, diethanolamine, 2-ethyl-1,3-hexanediol, N-methyl diisopropanolamine, 1,2-propanediol, 1,3-propanediol, 1,3-butanediol, 1,4-butanediol or 1,6-hexanediol. Per mole of the polyether diol or polyether diol mixture, 0.6-1.6 moles of the short-chain aliphatic diol or of the mixture of two short-chain aliphatic diols b) are used, preferably 0.7-1.5 moles and most particularly preferably 0.8-1.4 moles. A mixture of 1,4-butanediol and 1,6-hexanediol in a molar ratio of 70:30 to 30:70 is preferred.

To produce the polyurethane coatings according to the invention, bifunctional aliphatic or cycloaliphatic amines are also employed as chain extenders (c). The amines may be employed as mixtures, the use of an individual diamine being preferred. Chain extenders of this type are hydrazine or aliphatic diamines, e.g. ethylenediamine, propylenediamine, 1,6-hexamethylenediamine or other aliphatic diamines. In addition, cycloaliphatic diamines, such as 1,4-bis(aminomethyl)-cyclohexane, 4,4′-diamino-3,3′-dimethyldicyclohexylmethane and other (C₁-C₄) di- and tetraalkyldicyclohexylmethanes, e.g. 4,4′-diamino-3,5-diethyl-3′,5′-diisopropyl-di cyclohexylmethane, are also suitable. 1-Amino-3,3,5-trimethyl-5-aminomethyl-cyclohexane (isophorone diamine) and 4,4′-diaminodicyclohexylmethane are preferably used.

Per mole of macrodiol mixture (a) 0.05-0.35 moles of chain extenders (c) are used, preferably 0.08-0.33 moles, most particularly preferably 0.10-0.30 moles.

Suitable as diisocyanates (d) are all aromatic isocyanates known to the person skilled in the art having an average NCO functionality of 2.0, which may be used individually or in any mixtures with one another, it being immaterial whether these were produced by phosgene or phosgene-free methods. Suitable examples of aromatic isocyanates d) are: 1,3- and 1,4-phenyl diisocyanate, toluene 2,4- and 2,6-diisocyanate and any mixtures of these isomers, diphenylmethane 2,4′-diisocyanate, diphenylmethane 4,4′-diisocyanate and mixtures of these two isomers and naphthylene-1,5-diisocyanate. Diphenylmethane 4,4′-diisocyanate is particularly suitable. Per mole of macrodiol mixture (a) 1.7-3.0 moles of diisocyanate component (d) are used, preferably 1.8-2.9 moles, most particularly preferably 1.9-2.8 moles.

Approximately equivalent quantities of aliphatic diamine chain extender c) are generally used, based on remaining isocyanate d), deducting the proportion of isocyanate that has reacted with the macrodiol mixture and with the low molecular weight bifunctional alcohols. Preferably, however, less than the equivalent quantity is used, down to about 30-80% of the NCO groups. The remaining NCO groups can be reacted with monofunctional terminators such as aliphatic alcohols, aliphatic amines, 3-aminopropyl trialkoxysilanes, butanone oxime or morpholine. This prevents too high a growth in the molecular weight or crosslinking and branching reactions. It is preferable to use aliphatic monoalcohols, such as ethanol, n-propanol, iso-propanol, n-butanol, iso-butanol, n-hexanol, n-octanol and isomeric octanols such as 2-ethylhexanol.

To produce the polyurethane urea coatings according to the invention, the polyether diol or the polyether diol mixture, together with diisocyanate, are reacted together in the melt or in solution until all the hydroxyl groups are used up. For this purpose, a catalyst is added to accelerate urethane formation. These catalysts are either Lewis acids or Lewis bases and are widely described in the literature, e.g. in L. Thiele and R. Becker, Adv. Urethane Sci. Technol. 1993, 12, 59-85. The polyurethane ureas according to the invention can be produced with any catalysts. Examples of these catalysts are compounds of tin, zirconium, zinc, aluminium, titanium or bismuth. In a second step, the low molecular weight alcohols are then added in solution and reacted with the remaining isocyanate groups in the reaction mixture. Further solvent is added and the chain extending diamine is added in pure form or in organic solution. After the target viscosity is reached, the remaining residues of NCO are blocked by a monofunctional aliphatic alcohol, by an aliphatic amine, 3-aminopropyl trialkoxysilanes or butanone oxime.

Suitable as solvents e) for the production and application of the polyurethane urea coatings according to the invention are mixtures of linear and cyclic esters, ethers, alcohols and ketones. The quantity of the solvent mixture, based on the total weight of the polyurethane urea solution, is 40-85%. The solvent mixtures preferably contain γ-butyrolactone as the main component in addition to linear esters or ketones. Based on the total weight of the polyurethane solution, the proportion of solvents is between 10 wt. % and 80 wt. %. The proportion of solvents, based on the total polyurethane urea solution, is particularly preferably 50-75%, with the proportion of γ-butyrolactone, based on the total polyurethane urea solution, being between 15 wt. % and 75 wt. %. In addition, the solvent mixtures can also contain carboxylate esters, such as e.g. ethyl acetate, butyl acetate or 1-methoxy-2-propylacetate, as well as ketones, such as acetone, methyl ethyl ketone and methyl isobutyl ketone.

The polyurethane ureas according to the invention have melting points greater than 100° C., preferably of 120° C. to 160° C. They possess high adhesion and surface hardness, high elongation at break and breaking strength.

They can be applied in any concentrations, adjusted to the respective application or to the type of substrate to be coated; 15-60 wt. % solutions are preferably used, particularly preferably 25 to 50 wt. % solutions.

The polyurethane urea solutions according to the invention are preferably used for the coating of textile fabrics and leather. The application can take place directly by printing, spraying, knife coating or by means of a transfer coating. The polyurethane urea solutions according to the invention are of particular importance for the production of coating articles on textile substrates by the transfer process. In this process, the polyurethane urea solutions according to the invention are used as top coats which produce an add-on of 5 to 60 g/m² on the support fabric.

Conventional additives and auxiliary substances, such as agents to modify the handle, pigments, dyes, matting agents, UV stabilisers, phenolic antioxidants, light stabilisers, water-repellents and/or flow control auxiliaries, can also be used.

The finishes obtained with the polyurethane urea solutions according to the invention have very high fastness properties. Their high adhesion, hardness and breaking strength are particularly advantageous.

The advantages of the polyurethane urea solutions according to the invention are explained by comparative tests in the following examples.

All the references described above are incorporated by reference in their entireties for all useful purposes.

While there is shown and described certain specific structures embodying the invention, it will be manifest to those skilled in the art that various modifications and rearrangements of the parts may be made without departing from the spirit and scope of the underlying inventive concept and that the same is not limited to the particular forms herein shown and described.

### EXAMPLES

The dynamic viscosities of the polyisocyanate solutions were determined at 23° C. using a VT 550 viscometer, plate-cone measuring setup PK 100, from Haake (Karlsruhe, Germany). By taking measurements at different shear rates, it was ensured that the flow behaviour of the polyisocyanate mixtures employed, as well as that of the comparative products, corresponds to that of ideal Newtonian fluids. It is therefore unnecessary to state the shear rate.

The determination of the NCO content of the resins described in the examples and comparative examples took place by titration according to DIN 53 185. The NCO values given in the examples always relate to the weighed amount of the synthesis step of the reaction mixture under consideration and not to the overall solution.

The quantitative data given in % are understood to be wt. % unless otherwise specified, and relate to the overall solution obtained.

The hydrolysis tests of the films obtained from the polyurethane solutions were conducted in accordance with DIN EN 12280-3.

### Example 1

This example describes the preparation of a polyurethane urea solution according to the invention.

157.3 g of a bifunctional propylene oxide polyether having an average molecular weight of 1991 g/mol and 77.6 g of a bifunctional propylene oxide polyether having an average molecular weight of 983 g/mol were weighed into a 3-litre stirred vessel with a stirring, cooling and heating device. Next, 153.7 g γ-butyrolactone were added and the mixture was heated to 50° C. 86.8 g of diphenylmethane 4,4′-diisocyanate (4,4′-MDI) were first added, and then also 150 mg dibutyltin dilaurate. An exothermic reaction started, with the temperature of the mixture rising to 78° C. Stirring was continued for 15 min, during which time the temperature of the reaction mixture was allowed to fall to 60° C. The isocyanate value of the mixture was determined as 3.1% NCO and was somewhat lower than the theoretical value.

At 60° C. a solution of 9.0 g 1,4-butanediol and 5.9 g 1,6-hexanediol in 75 g γ-butyrolactone was added dropwise within 10 min. The temperature rose as a result of the exothermic reaction to 70° C. On completion of the addition, stirring was continued for a further 20 min, during which time the temperature fell slowly back to 60° C. The NCO content of the reaction mixture was determined as 0.54% NCO. On completion of this reaction step, 467 g γ-butyrolactone and 218 g 1-methoxy-2-propyl acetate were added at 60° C. The temperature was allowed to fall to 40° C. as a result. At a reaction temperature of 35-40° C. a solution of 3.3 g isophorone diamine dissolved in 31.1 g methyl ethyl ketone was added in portions. A strongly increasing viscosity of the polyurethane urea solution formed was observed. By adding 0.5 g 2-ethylhexanol and continuing to stir for 1 h at 35° C., the isocyanate groups still present in the reaction mixture were reacted, so that it was no longer possible for a further increased in molecular weight to take place.

A 26.5% polyurethane urea solution with a viscosity of 24000 mPas was obtained.

### Example 2

This example describes the preparation of a polyurethane urea solution according to the invention.

156.0 g of a bifunctional propylene oxide polyether having an average molecular weight of 1975 g/mol and 77.2 g of a bifunctional propylene oxide polyether having an average molecular weight of 978 g/mol were weighed into a 3-litre stirred vessel with a stirring, cooling and heating device. Next, 153.7 g γ-butyrolactone were added and the mixture was heated to 50° C. 86.8 g of diphenylmethane 4,4′-diisocyanate (4,4′-MDI) were first added, and then also 150 mg BorchiKat 24 (bismuth-containing catalyst from Borchers, Langenfeld, Germany). An exothermic reaction started, with the temperature of the mixture rising to 70° C. Stirring was continued for 13 min, during which time the temperature of the reaction mixture was allowed to fall to 60° C. The isocyanate value of the mixture was determined as 3.2% NCO and was somewhat lower than the theoretical value.

At 60° C. a solution of 9.0 g 1,4-butanediol and 5.9 g 1,6-hexanediol in 75 g γ-butyrolactone was added dropwise within 12 min. The temperature rose as a result of the exothermic reaction to 64° C. On completion of the addition, stirring was continued for a further 20 min, during which time the temperature fell slowly back to 60° C. The NCO content of the reaction mixture was determined as 0.56% NCO. On completion of this reaction step, 467 g γ-butyrolactone and 100 g 1-methoxy-2-propyl acetate were added at 60° C. The temperature was allowed to fall to 40° C. as a result. At a reaction temperature of 35-40° C. a solution of 4.0 g isophorone diamine dissolved in 31.6 g methyl ethyl ketone was added in portions. A strongly increasing viscosity of the polyurethane urea solution formed was observed. By adding 1.0 g 2-ethylhexanol and continuing to stir for 1 h at 35° C., the isocyanate groups still present in the reaction mixture were reacted, so that it was no longer possible for a further increase in molecular weight to take place.

A 29.1% polyurethane urea solution with a viscosity of 54000 mPas was obtained.

### Example 3

This example describes the preparation of a polyurethane urea solution according to the invention.

156.0 g of a bifunctional propylene oxide polyether having an average molecular weight of 1975 g/mol and 77.6 g of a bifunctional propylene oxide polyether having an average molecular weight of 978 g/mol were weighed into a 3-litre stirred vessel with a stirring, cooling and heating device. Next, 153.7 g γ-butyrolactone were added and the mixture was heated to 50° C. 86.8 g of diphenylmethane 4,4′-diisocyanate (4,4′-MDI) were first added, and then also 150 mg dibutyltin dilaurate. An exothermic reaction started, with the temperature of the mixture rising to 65° C. Stirring was continued for 16 min, during which time the temperature of the reaction mixture was allowed to fall to 60° C. The isocyanate value of the mixture was determined as 3.2% NCO and was somewhat lower than the theoretical value.

At 60° C. a solution of 9.0 g 1,4-butanediol and 5.9 g 1,6-hexanediol in 75 g γ-butyrolactone was added dropwise within 12 min. The temperature rose as a result of the exothermic reaction to 64° C. On completion of the addition, stirring was continued for a further 26 min, during which time the temperature fell slowly back to 60° C. The NCO content of the reaction mixture was determined as 0.57% NCO. On completion of this reaction step, 467 g γ-butyrolactone and 57.0 g 1-methoxy-2-propyl acetate were added at 60° C. The temperature was allowed to fall to 40° C. as a result. At a reaction temperature of 35-40° C. a solution of 3.6 g isophorone diamine dissolved in 25.8 g methyl ethyl ketone was added in portions. A strongly increasing viscosity of the polyurethane urea solution formed was observed. By adding 1.5 g 2-ethylhexanol and continuing to stir for 1 h at 35° C., the isocyanate groups still present in the reaction mixture were reacted, so that it was no longer possible for a further increase in molecular weight to take place.

A 30.4% polyurethane urea solution with a viscosity of 50000 mPas was obtained.

### Example 4

This example describes the preparation of a polyurethane urea solution according to the invention.

137.4 g of a bifunctional propylene oxide polyether having an average molecular weight of 1991 g/mol and 67.8 g of a bifunctional propylene oxide polyether having an average molecular weight of 983 g/mot were weighed into a 3-litre stirred vessel with a stirring, cooling and heating device. Next, 153.7 g γ-butyrolactone were added and the mixture was heated to 50° C. 86.8 g of diphenylmethane 4,4′-diisocyanate (4,4′-MDI) were first added, and then also 150 mg dibutyltin dilaurate. An exothermic reaction started, with the temperature of the mixture rising to 68° C. Stirring was continued for 17 min, during which time the temperature of the reaction mixture was allowed to fall to 60° C. The isocyanate value of the mixture was determined as 3.8% NCO and was somewhat lower than the theoretical value.

At 60° C. a solution of 10.2 g 1,4-butanediol and 6.7 g 1,6-hexanediol in 75 g γ-butyrolactone was added dropwise within 12 min. The temperature rose as a result of the exothermic reaction to 65° C. On completion of the addition, stirring was continued for a further 31 min, during which time the temperature fell slowly back to 60° C. The NCO content of the reaction mixture was determined as 0.57% NCO. On completion of this reaction step, 467 g γ-butyrolactone and 110 g 1-methoxy-2-propyl acetate were added at 60° C. The temperature was allowed to fall to 40° C. as a result. At a reaction temperature of 35-40° C. a solution of 2.7 g isophorone diamine dissolved in 27.8 g methyl ethyl ketone was added in portions. A strongly increasing viscosity of the polyurethane urea solution formed was observed. By adding 3.5 g 2-ethylhexanol and continuing to stir for 1 h at 35° C., the isocyanate groups still present in the reaction mixture were reacted, so that it was no longer possible for a further increase in molecular weight to take place.

A 27.4% polyurethane urea solution with a viscosity of 34100 mPas was obtained.

### Example 5

This example describes the preparation of a polyurethane urea solution according to the invention.

136.3 g of a bifunctional propylene oxide polyether having an average molecular weight of 1975 g/mol and 67.5 g of a bifunctional propylene oxide polyether having an average molecular weight of 978 g/mol were weighed into a 3-litre stirred vessel with a stirring, cooling and heating device. Next, 153.7 g γ-butyrolactone were added and the mixture was heated to 50° C. 86.8 g of diphenylmethane 4,4′-diisocyanate (4,4′-MDI) were first added, and then also 150 mg dibutyltin dilaurate. An exothermic reaction started, with the temperature of the mixture rising to 71° C. Stirring was continued for 11 min, during which time the temperature of the reaction mixture was allowed to fall to 60° C. The isocyanate value of the mixture was determined as 3.8% NCO and was somewhat lower than the theoretical value.

At 60° C. a solution of 9.0 g 1,4-butanediol and 8.3 g 1,6-hexanediol in 75 g γ-butyrolactone was added dropwise within 15 min. The temperature rose as a result of the exothermic reaction to 69° C. On completion of the addition, stirring was continued for a further 29 min, during which time the temperature fell slowly back to 60° C. The NCO content of the reaction mixture was determined as 0.56% NCO. On completion of this reaction step, 467 g γ-butyrolactone were added at 60° C. The temperature was allowed to fall to 40° C. as a result. At a reaction temperature of 35-40° C. a solution of 3.6 g isophorone diamine dissolved in 28.8 g methyl ethyl ketone was added in portions. A strongly increasing viscosity of the polyurethane urea solution formed was observed. By adding 4.5 g 2-ethylhexanol and continuing to stir for 1 h at 35° C., the isocyanate groups still present in the reaction mixture were reacted, so that it was no longer possible for a further increase in molecular weight to take place.

A 30.4% polyurethane urea solution with a viscosity of 45800 mPas was obtained.

### Example 6

This example describes the preparation of a polyurethane urea solution according to the invention.

136.3 g of a bifunctional propylene oxide polyether having an average molecular weight of 1975 g/mol and 67.5 g of a bifunctional propylene oxide polyether having an average molecular weight of 978 g/mol were weighed into a 3-litre stirred vessel with a stirring cooling and heating device. Next, 153.7 g γ-butyrolactone were added and the mixture was heated to 5° C. 86.8 g of diphenylmethane 4,4′-diisocyanate (4,4′-MDI) were first added, and then also 150 mg dibutyltin dilaurate. An exothermic reaction started, with the temperature of the mixture rising to 70° C. Stirring was continued for 16 min, during which time the temperature of the reaction mixture was allowed to fall to 60° C. The isocyanate value of the mixture was determined as 3.9% NCO.

At 60° C. a solution of 7.7 g 1,4-butanediol and 10.0 g 1,6-hexanediol in 75 g γ-butyrolactone was added dropwise within 12 min. The temperature rose as a result of the exothermic reaction to 70° C. On completion of the addition, stirring was continued for a further 23 min, during which time the temperature fell slowly back to 60° C. The NCO content of the reaction mixture was determined as 0.56% NCO. On completion of this reaction step, 467 g γ-butyrolactone were added at 60° C. The temperature was allowed to fall to 40° C. as a result. At a reaction temperature of 35-40° C. a solution of 5.2 g isophorone diamine dissolved in 38.1 g methyl ethyl ketone was added in portions. A strongly increasing viscosity of the polyurethane urea solution formed was observed. By adding 3.5 g 2-ethylhexanol and continuing to stir for 1 h at 35° C., the isocyanate groups still present in the reaction mixture were reacted, so that it was no longer possible for a further increase in molecular weight to take place.

A 30.2% polyurethane urea solution with a viscosity of 34800 mPas was obtained.

### Example 7

This example describes the preparation of a polyurethane urea solution according to the invention.

126.4 g of a bifunctional propylene oxide polyether having an average molecular weight of 1975 g/mol and 72.4 g of a bifunctional propylene oxide polyether having an average molecular weight of 978 g/mol were weighed into a 3-litre stirred vessel with a stirring, cooling and heating device. Next, 153.7 g γ-butyrolactone were added and the mixture was heated to 50° C. 86.8 g of diphenylmethane 4,4′-diisocyanate (4,41-MDI) were first added, and then also 150 mg dibutyltin dilaurate. An exothermic reaction started, with the temperature of the mixturerising to 71° C. Stirring was continued for 14 min, during which time the temperature of the reaction mixture was allowed to fall to 60° C. The isocyanate value of the mixture was determined as 3.9% NCO.

At 60° C. a solution of 7.7 g 1,4-butanediol and 10.0 g 1,6-hexanediol in 75 g γ-butyrolactone was added dropwise within 12 min. The temperature rose as a result of the exothermic reaction to 63° C. On completion of the addition, stirring was continued for a further 26 min, during which time the temperature fell slowly back to 60° C. The NCO content of the reaction mixture was determined as 0.57% NCO. On completion of this reaction step, 456.9 g γ-butyrolactone were added at 60° C. The temperature was allowed to fall to 40° C. as a result. At a reaction temperature of 35-40° C. a solution of 4.0 g isophorone diamine dissolved in 28.1 g methyl ethyl ketone was added in portions. A strongly increasing viscosity of the polyurethane urea solution formed was observed. By adding 5.0 g 2-ethylhexanol and continuing to stir for 1 h at 35° C., the isocyanate groups still present in the reaction mixture were reacted, so that it was no longer possible for a further increase in molecular weight to take place.

A 30.4% polyurethane urea solution with a viscosity of 68000 mPas was obtained.

### Example 8

This example describes the preparation of a polyurethane urea solution according to the invention.

146.2 g of a bifunctional propylene oxide polyether having an average molecular weight of 1975 g/mol and 62.6 g of a bifunctional propylene oxide polyether having an average molecular weight of 978 g/mol were weighed into a 3-litre stirred vessel with a stirring, cooling and heating device. Next, 153.7 g γ-butyrolactone were added and the mixture was heated to 50° C. 86.8 g of diphenylmethane 4,4′-diisocyanate (4,4′-MDI) were first added, and then also 150 mg dibutyltin dilaurate. An exothermic reaction started, with the temperature of the mixture rising to 71° C. Stirring was continued for 9 min, during which time the temperature of the reaction mixture was allowed to fall to 60° C. The isocyanate value of the mixture was determined as 3.9% NCO.

At 60° C. a solution of 7.7 g 1,4-butanediol and 10.0 g 1,6-hexanediol in 75 g γ-butyrolactone was added dropwise within 12 min. The temperature rose as a result of the exothermic reaction to 65° C. On completion of the addition, stirring was continued for a further 29 min, during which time the temperature fell slowly back to 60° C. The NCO content of the reaction mixture was determined as 0.56% NCO. On completion of this reaction step, 467 g γ-butyrolactone were added at 60° C. The temperature was allowed to fall to 40° C. as a result. At a reaction temperature of 35-40° C. a solution of 3.1 g isophorone diamine dissolved in 24.4 g methyl ethyl ketone was added in portions. A strongly increasing viscosity of the polyurethane urea solution formed was observed. By adding 5.5 g 2-ethylhexanol and continuing to stir for 1 h at 35° C., the isocyanate groups still present in the reaction mixture were reacted, so that it was no longer possible for a further increase in molecular weight to take place.

A 30.9% polyurethane urea solution with a viscosity of 54600 mPas was obtained.

### Example 9

This example describes the preparation of an adhesive coat solution from the prior art in a solvent mixture containing DMF.

300.0 g of a bifunctional propylene oxide polyether having an average molecular weight of 2000 g/mol were weighed into a 3-litre stirred vessel with a stirring, cooling and heating device. Next, 105.0 g dimethylformamide (DMF) were added and the mixture was heated to 60° C. 115.5 g of diphenylmethane 4,4′-diisocyanate (4,4′-MDI) were added, and the mixture was heated to 75° C. within 15 min. When the temperature reached 75° C., stirring was continued at this temperature for a further 40 min. The isocyanate value of the mixture was determined as 4.9% and was just below the theoretically expected value.

The mixture was then cooled to 55° C. and at this temperature a solution of 23.0 g 1,4-butanediol in 201.3 g DMF was added dropwise within 13 min. At the end of the dropwise addition, the reaction mixture was heated to 75° C. within 17 min and stirred at this temperature for a further 45 min. On completion of the reaction, the isocyanate value was determined at a value of 0.53%.

On completion of this reaction step the batch was cooled to 50° C., and then 232.5 g methyl ethyl ketone and 231.0 g toluene were added. The temperature was allowed to fall to 40° C. as a result. At a reaction temperature of 35-40° C. a solution of 3.5 g isophorone diamine dissolved in 38.4 g toluene was added in portions. A strongly increasing viscosity of the polyurethane urea solution formed was observed. By adding 4.0 g 3-aminopropyl triethoxysilane and continuing to stir for 1 h at 35° C., the isocyanate groups still present in the reaction mixture were reacted, so that it was no longer possible for a further increase in molecular weight to take place.

A 35.6% polyurethane urea solution with a viscosity of 20800 mPas was obtained.

### Example 10

This example describes the preparation of an adhesive coat from the prior art without the use of DMF and toluene.

300.0 g of a bifunctional propylene oxide polyether having an average molecular weight of 2000 g/mol were weighed into a 3-litre stirred vessel with a stirring, cooling and heating device. Next, 105.0 g γ-butyrolactone were added and the mixture was heated to 60° C. 115.5 g of diphenylmethane 4,4′-diisocyanate (4,4′-MDI) were added, and the mixture was heated to 73° C. within 25 min. When the reaction temperature was reached, stirring was continued at this temperature for a total of 8.75 h with an interruption. The isocyanate value of the mixture was determined as 5.1%.

The mixture was then cooled to 50° C. and at this temperature a solution of 23.0 g 1,4-butanediol in 201.3 g γ-butyrolactone was added dropwise within 20 min. The mixture was heated to 74° C. and stirred at this temperature for 1.25 h at 74° C. and 45 min at 90° C. On completion of the reaction, the isocyanate value is determined at a value of 0.45%.

On completion of this reaction step the batch was cooled to 50° C. and then 232.5 g methyl ethyl ketone and 231.0 g butyl acetate were added. The temperature was allowed to fall to 40° C. as a result. At a reaction temperature of 35-40° C. a solution of 3.7 g isophorone diamine dissolved in 40.0 g butyl acetate was added in portions. A strongly increasing viscosity of the polyurethane urea solution formed was observed. By adding 3.5 g 3-aminopropyl triethoxysilane and continuing to stir for 1 h at 35° C., the isocyanate groups still present in the reaction mixture were reacted, so that it was no longer possible for a further increase in molecular weight to take place.

On completion of the reaction and after cooling to room temperature, a markedly cloudy product was obtained. The polyurethane urea was insufficiently soluble in the selected solvent system without DMF and could not therefore be used as an adhesive coat system.

### Example 11

### Example of Use

To compare the coating properties, coating films were prepared in a film thickness of 0.15 mm from the polyurethane solutions according to examples 1 to 8 and comparative example 9 (product according to the prior art with DMF and toluene as solvents) and tested.

TABLE 1
Results of the film tests

| | 100% | Tensile | | |
|---|---|---|---|---|
| | modulus | strength | Elongation at | Softening point |
| Example No. | (MPa) | (MPa) | break (%) | (° C.) |
| 1 | 0.9 | 8.2 | 2930 | 140 |
| 2 | 0.8 | 2.9 | 2770 | 160 |
| 3 | 0.7 | 3.8 | 3000 | 165 |
| 4 | 1.3 | 16 | 1700 | 150 |
| 5 | 0.9 | 14.2 | 2440 | 120 |
| 6 | 0.9 | 14.6 | 2450 | 125 |
| 7 | 1.0 | 17.5 | 2070 | 120 |
| 8 | 0.9 | 13.7 | 2680 | 125 |
| 9 | 1.8 | 17.2 | 1340 | 160 |
| (Comparative | | | | |
| example) | | | | |

These results show that polyurethane solutions according to the invention make it possible to produce coatings that can be made using toxicologically harmless organic solvents. Using different products it is possible to obtain a wide range of physical properties of the films.

1. A polyurethane urea solution obtained by reacting
a) a bifunctional polyether diol having a molecular weight in the range of from 500 to 16000 or mixtures of these bifunctional macrodiols;
b) from 0.6 to 1.6 moles, per mole of a), of a low molecular weight bifunctional alcohol having a molecular weight in the range of from 32 to 500 or mixtures of these bifunctional alcohols;
c) from 0.05 to 0.35 moles, per mole of a), of an aliphatic or cycloaliphatic bifunctional amine having a molecular weight in the range of from 28 to 500 or mixtures of these bifunctional amines;
d) from 1.7 to 3.0 moles, per mole of a), of an aromatic diisocyanate;
wherein the overall functionality of a) is in the range of from 1.95 to 2.05;
to form a polyurethane urea, wherein said polyurethane urea is dissolved in or prepared in
e) from 40 to 85 weight %, based on the total weight of (a) through (e), of a solvent selected from the group consisting of linear and cyclic esters, linear and cyclic ethers, linear and cyclic alcohols, and linear and cyclic ketones.

2. The polyurethane urea solution of claim 1, wherein
a) is a mixture of two bifunctional polyether diols each having a molecular weight in the range of from 500 to 5000, wherein the molar mixing ratio of said two bifunctional polyether diols is in the range of from 10:90 to 90:10;
b) is from 0.7 to 1.5 moles, per mole of a), of a mixture of two low molecular weight bifunctional alcohols each having a molecular weight in the range of from 32 to 500, wherein the molar mixing ratio of said two low molecular weight bifunctional alcohols is in the range of from 10:90 to 90:10;
c) is from 0.08 to 0.33 moles, per mole of a), of an aliphatic or cycloaliphatic bifunctional amine having a molecular weight in the range of from 28 to 500;
d) is from 1.8 to 2.9 moles, per mole of a), of an aromatic diisocyanate; and
e) is from 40 to 95 weight % of a solvent selected from the group consisting of linear and cyclic esters and linear and cyclic ketones.

3. The polyurethane urea solution of claim 1, wherein
a) is a mixture of two bifunctional polyether diols each having a molecular weight in the range of from 500 to 5000, wherein the molar mixing ratio of said two bifunctional polyether diols is in the range of from 30:70 to 70:30;
b) is from 0.8 to 1.4 moles, per mole of a), of a mixture of two low molecular weight bifunctional alcohols each having a molecular weight in the range of from 32 to 500, wherein the molar mixing ratio of said two low molecular weight bifunctional alcohols is in the range of from 30:70 to 70:30;
c) is from 0.10 to 0.30 moles, per mole of a), of an aliphatic or cycloaliphatic bifunctional amine having a molecular weight of from 28 to 500;
d) is from 1.9 to 2.8 moles, per mole of a), of diphenylmethane 4,4′-diisocyanate; and =
e) is from 50 to 75 weight % of a solvent mixture consisting of γ-butyrolactone together with esters and ketones.

4. A coating prepared from the polyurethane urea solution of claim 1.

5. A coating prepared from the polyurethane urea solution of claim 2.

6. A coating prepared from the polyurethane urea solution of claim 3.

7. A substrate coated with the coating of claim 4.

8. A substrate coated with the coating of claim 5.

9. A substrate coated with the coating of claim 6.

10. The substrate of claim 7, wherein said polyurethane urea solution is applied to said substrate by printing, spraying, knife coating, or transfer coating.

11. The substrate of claim 8, wherein said polyurethane urea solution is applied to said substrate by printing, spraying, knife coating, or transfer coating.

12. The substrate of claim 9, wherein said polyurethane urea solution is applied to said substrate by printing, spraying, knife coating, or transfer coating.

13. The substrate of claim 7, wherein said substrate is a textile.

14. The substrate of claim 8, wherein said substrate is a textile.

15. The substrate of claim 9, wherein said substrate is a textile.

16. The substrate of claim 7, wherein said substrate is leather.

17. The substrate of claim 8, wherein said substrate is leather.

18. The substrate of claim 9, wherein said substrate is leather.

19. The coating of claim 4, wherein said coating is an adhesive coating.

20. The coating of claim 5, wherein said coating is an adhesive coating.

21. The coating of claim 6, wherein said coating is an adhesive coating.
